(19) United States
(12) Patent Application Publication
(10) Pub. No.: US 2004/0175459 A1
(43) Pub. Date: Sep. 9, 2004

(54) Method for producing an aqueous beverage containing sporogenous lactic bacteria

(76) Inventor: Te-Chih Ting, Chia-Yi Hsien (TW)

Correspondence Address: DELLETT AND WALTERS, P. O. BOX 2786, PORTLAND, OR, 97208-2786, US

(21) Appl. No.: 10/384,127

(22) Filed: Mar. 6, 2003

(51) Int. Cl. A23C 9/12

(52) U.S. Cl. 426/42

(57) ABSTRACT

A method for producing an aqueous beverage containing sporogenous lactic bacteria in accordance with the present invention uses dormant sporogenous lactic bacterium in a water solution. The dormant state is achieved by making the sporogenous lactic bacteria produce endospores so the sporogenous lactic bacteria will have excellent endurance in a water solution at room temperature and even extreme conditions in the digestive system. The dormant sporogenous lactic bacteria specifically revive in the intestines. Therefore, the aqueous beverage containing sporogenous lactic bacterium can be stored without being refrigerated and has a long preserving life. Moreover, the lactic bacterium actually develops its beneficial features in the intestines.

### BACKGROUND OF THE INVENTION

1. Field of the Invention

The present invention relates to a method for producing an aqueous beverage containing lactobacillus, and more particularly to a method for producing an aqueous beverage that contains sporogenous lactic bacteria that survive in a person's digestive tract until it reaches the intestines.

2. Description of Related Art

Lactic bacterium plays an important role in our daily life and produces lactic acid to depress the pH value in our intestines. Moreover, lactic bacterium such as lactobacillus has beneficial features such as depressing the growth of harmful bacteria in our intestines, stimulating the growth of beneficial bacteria, synthesizing vitamins, enhancing immunity and metabolism and promoting intestinal peristalsis. These features make the popular beverages containing lactobacillus beneficial.

Beverages containing lactobacillus are mainly of two kinds in the market:

1. Fermented lactic beverage: milk is mixed with selected lactobacillus, ferments and becomes sour forming a fermented dairy product. The fermented dairy product is further mixed with edible flavoring and sugar to produce a fermented lactic beverage. However, the lactobacillus in the fermented lactic beverage has a life of about a week and has to be maintained in a temperature range of 4˜7° C. during transportation and display for sale. These drawbacks make the production, transportation and storage of the fermented lactic beverages difficult and expensive. Furthermore, lactobacillus is sensitive to pH value and easily deteriorates or even dies due to environmental changes before the lactobacillus arrives in the intestines. Therefore, the lactobacillus perishes when it passes through user's oral cavity, stomach, or duodenum and cannot carry its beneficial properties to the intestines.

2. Fermented lactic beverage containing processed lactobacillus (capsule): to protect the frail lactobacillus in the digestive system, the lactobacillus is coated with gelatin or starch that dissolves in the intestines to make a capsule. Then, the capsules are added to the fermented diary products to ensure the lactobacillus is still alive when it reaches the intestines. Although the fermented lactic beverage containing capsules performs better than the conventional fermented lactic beverage, the product cost is higher than the conventional fermented lactic beverage since the lactobacillus requires extra processing. The product cost of the capsule fermented lactic beverage is also shifted to the consumers.

Moreover, these two kinds of lactic beverages are made of dairy product such as milk and have plenty of carbohydrate, starch, protein and fat. Because these lactic beverages have high calories, they can contribute adversely to a user being overweight and other preexisting conditions such as diabetes or nephrosis.

Because these two kinds of lactic beverages have to be stored at a low temperature to keep the lactobacillus alive, refrigerating devices are required during manufacturing, transportation and storage. Therefore, the lactic beverages have high product costs and require extra care in all processes.

The present invention has arisen to mitigate or obviate the disadvantages of the conventional lactic beverages.

### SUMMARY OF THE INVENTION

A first objective of the present invention is to provide a method for producing an aqueous beverage containing sporogenous lactic bacteria that reduces the product cost relative to conventional lactic beverages and keeps the lactobacillus alive until it arrives in the intestines so its beneficial features can be imparted to the human body.

A second objective of the present invention is to provide a method for producing an aqueous beverage containing sporogenous lactic bacteria that uses water as the fundamental solution to reduce calories and fat in the beverage for consumers who want to ingest lactobacillus but also need to limit caloric intake.

A third objective of the present invention is to provide a method for producing an aqueous beverage containing sporogenous lactic bacteria, which is convenient to produce, transport and store and has a long shelf-life.

Further benefits and advantages of the present invention will become apparent after a careful reading of the detailed description with appropriate reference to the accompanying drawings.

### BRIEF DESCRIPTION OF THE DRAWING

FIG. 1 is a block diagram of a method for producing an aqueous beverage containing sporogenous lactic bacteria in accordance with the present invention.

### DETAILED DESCRIPTION OF THE PREFERRED EMBODIMENT

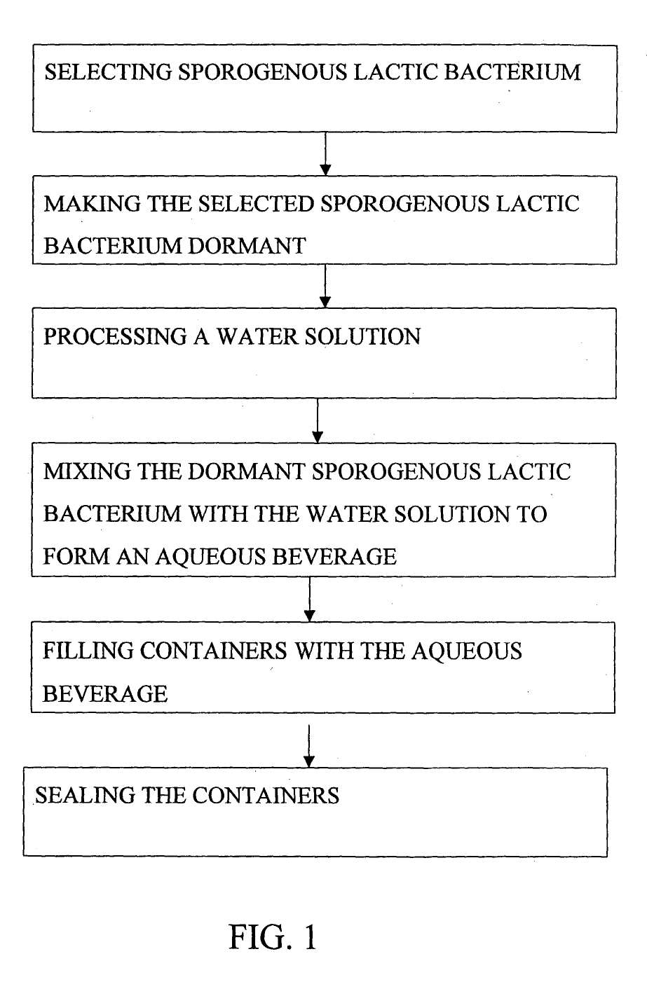

With reference to FIG. 1, a method for producing an aqueous beverage containing sporogenous lactic bacteria in accordance with the present invention comprises the acts of selecting sporogenous lactic bacterium, making the selected sporogenous lactic bacterium dormant; processing a water solution; mixing the dormant sporogenous lactic bacterium with the water solution to form an aqueous beverage; filling containers with the aqueous beverage; and sealing the containers.

The sporogenous lactic bacterium is the active ingredient in the product produced by the method in accordance with the present invention and is cultured in a suitable culturing procedure. Then, the cultured sporogenous lactic bacteria are screened and collected. The sporogenous lactic bacteria used in the present invention are bacillus coagulans and enterococcus faecium of anaerobic bacteria. These two kinds of sporogenous lactic bacteria produce endospores when stressed by extreme temperature, nutrient chemistry (i.e. pH, toxicity, etc.), or oxygen.

The selected sporogenous lactic bacteria are processed to make the sporogenous lactic bacteria enter a dormant state by controlling the conditions and media of the culturing process to create the stress on the sporogenous lactic bacteria to produce endospores.

Then, water is subjected to sterilizing means such as thermal treatment, filtering, ozone-sterilization or ultraviolet-sterilization. Additionally, edible pigments, condiments or other contents are selectively mixed with the water to enhance flavor of the aqueous beverage. Other equipment used in the steps is also sterilized to ensure the aqueous beverage is not contaminated.

The dormant sporogenous lactic bacteria are mixed with the sterilized water to form the aqueous beverage containing lactic bacteria, and then the aqueous beverage is poured into containers using a cool-filling technique at 25° C. or by a hot-filling technique at 55-100° C. In the hot-filling technique, temperature of 55-100° C. keeps the aqueous beverage in a sterile condition during filling but does not affect the sporogenous lactic bacteria.

Finally, containers are filled with the aqueous beverage and are sealed with aluminum foil using high-frequency sealing to produce the aqueous beverage product containing sporogenous lactic bacteria.

The aqueous beverage can be preserved at a room temperature or refrigerated. Since the water does not have enough nutrition and does not activate the dormant sporogenous lactic bacteria, the lactic bacteria will not revive so the aqueous beverage can be preserved for a long time.

After the aqueous beverage is drunk, the sporogenous lactic bacteria are protected from the extreme conditions in the digestive system by the endospores and arrive in the intestines in tact. Conditions in the intestines are conducive to growth of the sporogenous lactic bacteria and revive the dormant lactic bacteria. Such conditions are moderate pH value, a desired temperature about 40° C. and plenty of nutrients. Within these conditions, the endospores revive and grow into vegetative bodies to produce the beneficial features of the lactic bacteria in the host.

According to the forgoing description, the dormant sporogenous lactic bacteria can be preserved in the water solution for a long time and survive under extreme conditions in the digestive system until they arrive in the intestines. Therefore, the sporogenous lactic bacteria in the aqueous beverage produces its beneficial features.

Meanwhile, water is used as the main component the aqueous beverage to hold the lactic bacteria so the aqueous beverage has less calories and fat than conventional fermented lactic beverages produced from milk. With regard to dietary issues, drinking the aqueous beverage does not result in ingesting excessive calories and cholesterol, which is especially beneficial to people with diabetes and nephrosis.

With regard to the manufacturing process, the sporogenous lactic bacteria produce protective endospores simply by changing the culturing conditions. No extra equipment is required to process the lactic bacteria like the extra equipment required to produce conventional capsules of lactic bacteria. Therefore, the manufacturing process of the aqueous beverage is easier than the process to produce conventional fermented lactic beverages containing capsules.

Moreover, since the dormant sporogenous lactic bacteria is preserved at room temperature for a long time and only revives in the human intestines, the aqueous beverage can be stored without being refrigerated and has a long shelf-life. Thereby, product cost of the aqueous beverage is also reduced.

Although the invention has been explained in relation to its preferred embodiment, it is to be understood that many other possible modifications and variations can be made without departing from the spirit and scope of the invention as hereinafter claimed.

1. A method for producing an aqueous beverage containing sporogenous lactic bacteria comprising the acts of:
selecting sporogenous lactic bacterium, wherein the sporogenous lactic bacterium is cultured, screened and collected;
making the selected sporogenous lactic bacteria dormant, wherein the selected sporogenous lactic bacteria are made to enter a dormant state by controlling the culturing conditions of the culturing media until the sporogenous lactic bacteria produce entire endospores;
processing water, wherein the water solution is sterilized;
mixing the dormant sporogenous lactic bacteria and the water to produce an aqueous beverage, wherein the sterilized water is mixed with the dormant sporogenous lactic bacteria to produce the aqueous beverage containing sporogenous lactic bacteria;
filling containers with the aqueous beverage, wherein the aqueous beverage is poured into container; and
sealing the containers.

2. The method for producing an aqueous beverage as claimed in claim 1, wherein the sporogenous lactic bacterium is bacillus coagulans.

3. The method for producing an aqueous beverage as claimed in claim 1, wherein the sporogenous lactic bacterium is enterococcus faecium.

4. The method for producing an aqueous beverage as claimed in claim 1, wherein the water solution is sterilized by a thermal treatment.

5. The method for producing an aqueous beverage as claimed in claim 1, wherein the water solution is sterilized by filtering.

6. The method for producing an aqueous beverage as claimed in claim 1, wherein the water solution is sterilized by ozone-sterilization.

7. The method for producing an aqueous beverage as claimed in claim 1, wherein the water solution is sterilized by ultraviolet-sterilization.

8. The method for producing an aqueous beverage as claimed in claim 1, wherein the containers are filled with the aqueous beverage with a cool-filling technique at 25° C.

9. The method for producing an aqueous beverage as claimed in claim 1, wherein the containers are filled with the aqueous beverage with a hot-filling technique at 55-100° C.

10. The method for producing an aqueous beverage as claimed in claim 1, wherein edible additives selected from at least one of the group consisted of pigments, condiments and edible materials are further added to the water solution.
